(19) United States
(12) Patent Application Publication
(10) Pub. No.: US 2009/0152486 A1
(43) Pub. Date: Jun. 18, 2009

(54) PRESSURE ADJUSTING VALVE FOR VEHICLE FUEL LINE

(75) Inventors: Ha Dong Bong, Ansan-city (KR); Jin Yong Kim, Gwangmyeong-city (KR); Seunghwan Hwang, Hwaseong-city (KR); Il Joong Hwang, Ansan-city (KR); Tae Yeol Shin, Suwon-city (KR); Kwangsoon Choi, Ansan-city (KR); Sangmin Lee, Seoul (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/193,479

(22) Filed: Aug. 18, 2008

(30) Foreign Application Priority Data
Dec. 14, 2007 (KR) 10-2007-0131636

(51) Int. Cl. F16K 7/00; F16K 31/04

(52) U.S. Cl. 251/129.01; 251/331

(57) ABSTRACT

A pressure adjusting valve for a vehicle fuel line includes a diaphragm disposed in a housing and dividing the interior of the housing into first and second compartments. A valve plate is provided in the second compartment and attached to the diaphragm. A return unit is provided in the second compartment. An elastic member provides an elastic force to the diaphragm toward the second compartment. An elastic force adjusting unit controls the elastic force of the elastic member.

### CROSS-REFERENCE TO RELATED APPLICATION

This application claims priority to, and the benefit of, Korean Patent Application No. 10-2007-0131636, filed in the Korean Intellectual Property Office on Dec. 14, 2007, the entire contents of which are incorporated herein by reference.

### BACKGROUND OF THE INVENTION

(a) Field of the Invention

The present invention relates to a pressure adjusting valve for a vehicle fuel line.

(b) Description of the Related Art

A typical pressure adjusting valve includes a spring-biased diaphragm in a fuel hydraulic chamber. If pressure in the fuel hydraulic chamber overcomes the elastic force of the spring, the diaphragm is pushed open, such that the fuel is free to leave the valve through a fuel outlet hole.

This valve can only be open or closed, and thus is not capable of fine-tuning the fuel pressure.

The above information disclosed in this Background section is only for enhancement of understanding of the background of the invention and therefore it may contain information that does not form the prior art that is already known in this country to a person of ordinary skill in the art.

### SUMMARY OF THE INVENTION

A pressure adjusting valve for a vehicle fuel line includes a diaphragm disposed in a housing and dividing the interior of the housing into first and second compartments. A valve plate is provided in the second compartment and attached to the diaphragm. A return unit is provided in the second compartment. An elastic member provides an elastic force to the diaphragm toward the second compartment. An elastic force adjusting unit controls the elastic force of the elastic member.

The return unit may include a valve selectively contacting the valve plate, and an outlet for releasing fuel from the second compartment.

The elastic force adjusting unit may include a slider that is slidable within the first compartment and that contacts the elastic member, and a driving unit for controlling the position of the slider.

The driving unit may include a motor, a threaded control shaft connected with the motor, and a threaded portion of the housing connected with the control shaft, where the control shaft contacts the slider.

The slider may include a rotatable sphere, and the control shaft may contact the sphere.

A spring seat may be provided between the elastic member and the diaphragm.

### BRIEF DESCRIPTION OF THE DRAWINGS

FIG. 1 is a cross-sectional view of a pressure adjusting valve for a vehicle fuel line according to an exemplary embodiment of the present invention.

FIG. 2 is a block diagram of a first exemplary control system of a pressure adjusting valve for a vehicle fuel line.

FIG. 3 is a block diagram of a second exemplary control system of a pressure adjusting valve for a vehicle fuel line.

### DETAILED DESCRIPTION OF PREFERRED EMBODIMENTS

An exemplary embodiment of the present invention will hereinafter be described in detail with reference to the accompanying drawings.

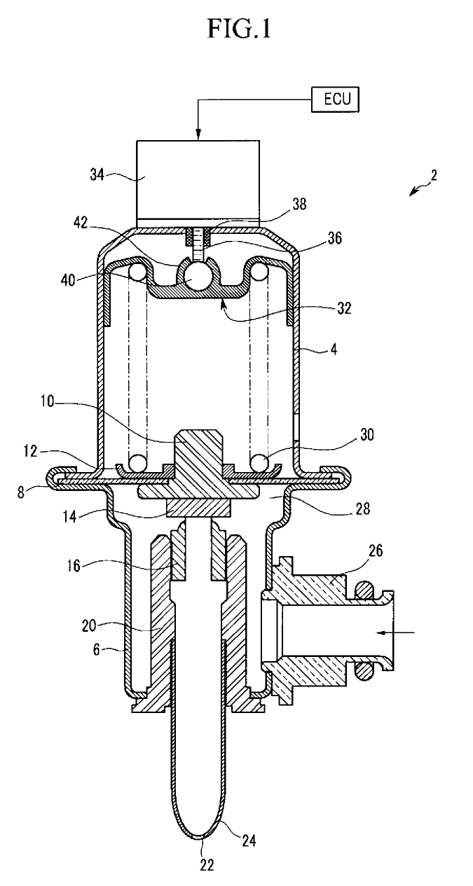

Referring to FIG. 1, a pressure adjusting valve 2 for a vehicle fuel line (not shown) includes a cylindrical upper housing 4 and a cylindrical lower housing 6. A diaphragm 8 is inserted between the upper housing 4 and the lower housing 6, and an inner body 10 is disposed in the diaphragm 8. A spring seat 12 is disposed on the diaphragm 8. A valve plate 14 is attached to the bottom of the inner body 10, and the valve plate 14 opens and closes a valve body 16 disposed within a bush 20. A fuel nipple 24 with an outlet 22 is disposed below the bush 20. A fuel inlet 26 is provided at a side of the lower housing 6. Fuel is supplied to a hydraulic chamber 28 below the diaphragm 8 through the fuel inlet 26.

Fuel pressure inside the hydraulic chamber 28 pushes the diaphragm 8. If the pressure inside of the hydraulic chamber 28 overcomes the elastic force on the diaphragm 8 as will be described below, the fuel passes through a gap between the valve plate 14 and the valve body 16. An elastic member 30, such as a coil spring, is disposed on the inner body 10 for supplying elastic force to the inner body 10. The elastic member 30 is disposed between the spring seat 12 and an elastic force adjusting unit, which includes a slider 32 that is slidably disposed within the upper housing 4. The elastic force adjusting unit also includes a driving unit that controls a position of the slider 32 according to control of an engine control unit (ECU). The driving unit includes a control motor 34, and a control shaft 36 that is connected with the control motor 34 and is screw coupled with a female thread member 38 of the upper housing 4.

An end of the control shaft 36 contacts a sphere 40 that is free to rotate within a seat 42 of the slider 32. Thus, the slider 32 moves up and down according to a rotating direction of the control motor 34.

The pressure adjusting valve 2 maintains the valve plate 14 against the valve body 16 when the pressure of the fuel inside the fuel hydraulic chamber 28 does not overcome the elastic force of the elastic member 30.

When the pressure of the fuel inside the fuel hydraulic chamber 28 does overcome the elastic force of the elastic member 30, the diaphragm 8 is pushed upward by the pressure inside the fuel hydraulic chamber 28 and a gap is formed between the valve plate 14 and the valve body 16. The fuel is returned to a fuel tank (not shown) through the gap, the valve body 16, and the fuel nipple 24, so that the pressure of a fuel line is maintained within a predetermined range.

If the pressure in the fuel line needs to be raised, the control motor 34 moves the slider 32 downwards, so that the pressure in the fuel line increases with increase of elastic force. If the pressure in the fuel line needs to be decreased, the control motor 34 moves the slider 32 upwards, so that the pressure in the fuel line decreases with decrease of elastic force.

The fuel pressure adjusting valve 2 may be applicable to both an ethanol and a gasoline engine. Because of the different air/fuel ratios in ethanol and gasoline engines, different injectors are typically used. However, the exemplary pressure adjusting valve 2 is applicable to both gasoline and ethanol engines.

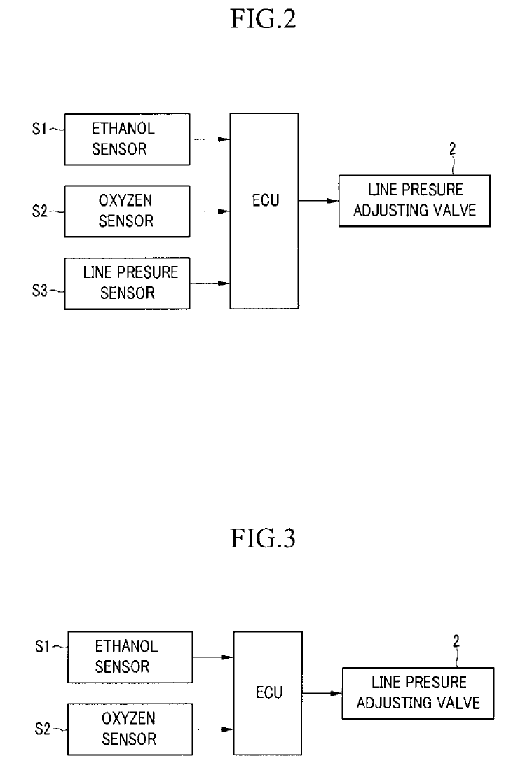

As shown in FIG. 2, for use in an ethanol engine, the ECU detects contents of ethanol from an ethanol sensor S1, or an inverse operation from an oxygen running value from an oxygen sensor S2, and detects the actual fuel pressure from a fuel pressure sensor S3, and then controls the fuel pressure adjusting valve 2 (via the control motor 34).

Alternatively, as shown in FIG. 3, the ECU controls the fuel pressure adjusting valve 2 (via the control motor 34) according to a theoretical air/fuel ratio without measuring the actual line pressure.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A pressure adjusting valve for a vehicle fuel line, comprising:
a housing;
a diaphragm disposed in the housing and dividing an interior of the housing into first and second compartments;
a valve plate disposed in the second compartment and attached to the diaphragm;
a return unit disposed in the second compartment;
an elastic portion for providing an elastic force to the diaphragm toward the second compartment; and
an elastic force adjusting unit for controlling the elastic force.

2. The pressure adjusting valve for a vehicle fuel line of claim 1, wherein the return unit comprises a valve selectively contacting the valve plate, and an outlet for releasing fuel from the second compartment.

3. The pressure adjusting valve for a vehicle fuel line of claim 1, wherein the elastic force adjusting unit comprises a slider that is slidably disposed within the first compartment and contacts the elastic portion, and a driving unit for controlling a position of the slider.

4. The pressure adjusting valve for a vehicle fuel line of claim 3, wherein the driving unit comprises a motor, a threaded control shaft connected with the motor, and a threaded portion of the housing connected with the control shaft, wherein the control shaft contacts the slider.

5. The pressure adjusting valve for a vehicle fuel line of claim 4, wherein the slider comprises a rotatable sphere, and wherein the control shaft contacts the sphere.

6. The pressure adjusting valve for a vehicle fuel line of claim 1, further comprising a spring seat disposed between the elastic portion and the diaphragm.
